(19) United States
(12) Patent Application Publication
(10) Pub. No.: US 2012/0040308 A1
(43) Pub. Date: Feb. 16, 2012

(54) HAND-HELD TEETH TREATMENT DEVICE

(76) Inventors: Thomas Bickford Holbeche, Hampshire (GB); Cormac John Devery, Surrey (GB); Geoffrey Morgan Lloyd, Sandhurst (GB)

(21) Appl. No.: 13/254,889

(22) PCT Filed: Mar. 9, 2010
(86) PCT No.: PCT/GB2010/000414

§ 371 Date: Oct. 5, 2011

(30) Foreign Application Priority Data
Mar. 11, 2009 (GB) 0904199.7

(51) Int. Cl. A61C 19/06

(52) U.S. Cl. 433/89

(57) ABSTRACT

The present invention provides a hand-held teeth treatment device 1. The device 1 comprises a base unit 2 which is configured to be hand-held and operated and at least one applicator 3 comprising an applicator head 4 for applying treatment to teeth. The applicator comprises a connecting portion 5 for engaging with a complementary connecting portion 6 of the base unit for connecting the applicator to the base unit. Treatment generating means 7 receives electrical energy from a source of electrical energy 8 for generating treatment for application by the applicator. The device may have a set of interchangeable applicators 3, each applicable to a different treatment. Treatment activation means 5, 6 allow activation of the treatment generating means only when the or one of the applicators 3 is connected to the base unit 2.

The present invention relates to a hand-held teeth treatment device, an applicator and set of applicators for the device and to a device for applying a plurality of different types of treatment to teeth, such by application of an active gaseous species. The present invention also relates to a teeth treatment kit.

An active gaseous species, for example, one contained in a non-thermal gaseous plasma, can be used in a number of different oral treatments. The active species may, for example, be used to combat dental caries or whiten teeth.

US-A-2004/0255409 relates to an electric toothbrush of a conventional kind, that is a device having a brush head which is contacted by the user with his or her own teeth in order to clean them. The electric toothbrush has a removable brush section having a transponder communicating with a handle portion of the toothbrush via a non-contacting inductive coupling. The data transmitted between the brush section and the handle section may include data for activating the motor or other driving means of the toothbrush.

The present invention provides a hand-held teeth treatment device or kit for applying a plurality of different types of treatment to teeth, comprising:

a base unit which is configured to be hand-held and -operated, and comprises a source of electrical energy;

a plurality of interchangeable applicators comprising applicator heads for applying different respective treatments to teeth, each of said applicators having a connecting portion for engaging with a complementary connecting portion of the base unit for connecting the applicator to the base unit such that any one of said applicators can be connected to said base unit;

treatment generating means for receiving electrical energy from said source, the treatment generating means being configured for generating an active gaseous species for application by at least a chosen one of the applicators when the chosen applicator is connected to said base unit; and

treatment activation means for allowing generation of a type of treatment according to the respective applicator connected to the base unit, wherein the connecting portion of each of said applicators comprises means co-operable with the connecting portion of the base unit for selecting the type of treatment which can be generated by the device when the applicator is connected to the base unit.

Accordingly, the treatment generating means can be activated only if an applicator is connected to the base unit.

The treatment generating means may be capable of generating any one of a plurality of different types of treatment and said treatment activation means allows generation of any one type of treatment only when a selected said applicator associated with said one type of treatment is connected to the base unit.

Accordingly, a user may be able to select from more than one type of treatment. The device is operable to deliver a selected type of treatment according to the type of applicator which is connected to the base unit.

One of the applicator and the base unit may comprise locking protrusions and the other of the applicator and the base unit may comprise locking recesses for receiving the locking protrusions for locking the applicator to the base unit. In a set of applicators for use in the device, each applicator may have a different configuration of locking recesses or locking protrusions.

The treatment generating means may additionally comprise a motor for moving said applicator head for treating teeth, for example, by reciprocating or rotating movement.

Each applicator head may be configured for applying one particular type of treatment to teeth and the connecting portion of said applicator is co-operable with said treatment activation means when the applicator is connected to the base unit for allowing generation of only that particular type of treatment by said treatment generating means.

At least one applicator may comprise a duct for connecting with a supply of active gaseous species generated in the base unit when the applicator is connected to the base unit for conveying species from the base unit to the applicator head; wherein the applicator head comprises at least one aperture therein in gas communication with the duct for applying species to an oral treatment region.

At least one applicator head may comprise an envelope which is sized and shaped to cover an inwardly and/or outwardly facing surface of one or more teeth and said at least one aperture is formed in the envelope for applying species to said teeth surface. The envelope may be shaped in the form of an arch and sized to cover the inwardly and/or outwardly facing surfaces of the upper and/or lower teeth and a respective plurality of said apertures are formed in said envelope for applying species to said inwardly and/or said outwardly facing teeth surfaces. The or each of the apertures may be configured to be in a closed condition to prevent the application of species to teeth and when clamped between upper and lower teeth, the apertures are opened to allow said application.

At least one applicator may comprise a motor for receiving electrical energy from said source when the applicator is connected to the base unit, said motor when activated causing movement of said applicator head. The applicator head may comprise a brush and said motor is adapted for causing one of reciprocating, rotational or vibrational movement of said brush.

The invention also provides a teeth treatment kit comprising a device as described above, there being a plurality of applicators, each applicator enabling a different treatment to be performed, whereby a user can select from the plurality of applicators a particular one to perform a particular treatment.

The device may be self-contained wherein during application of treatment said treatment generation means generates treatment without the device being connected to a remote source of gas and/or power.

In order that the present invention may be well understood, embodiments thereof, which are given by way of example only, will now be described with reference to the accompanying drawings, in which:

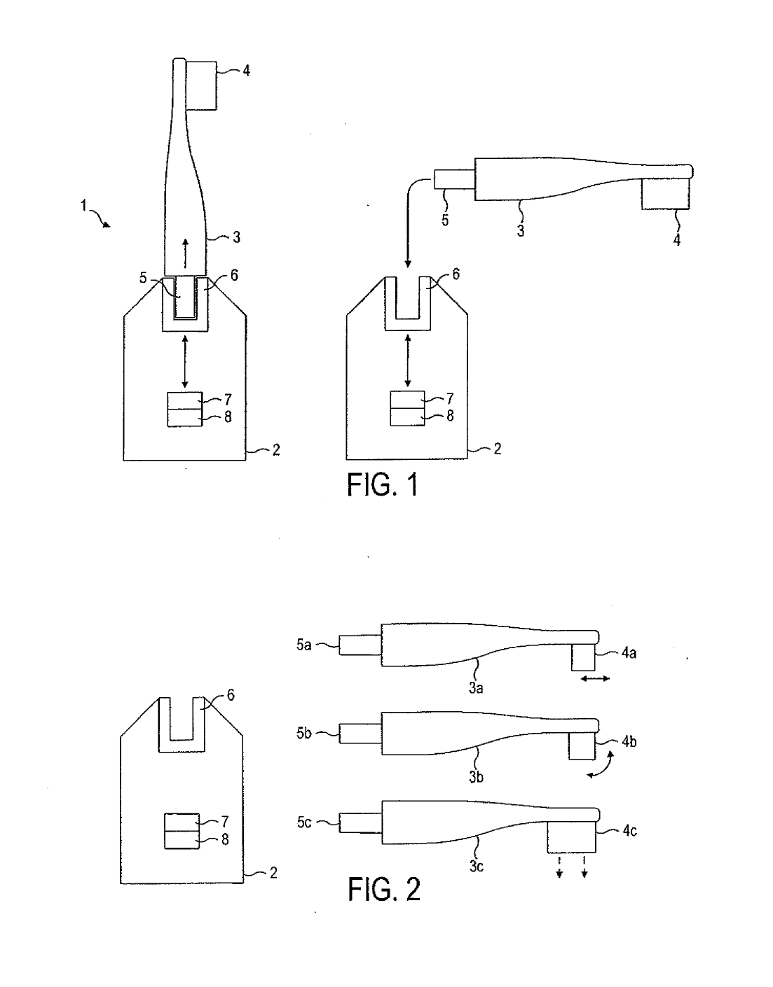

FIG. 1 shows a hand-held teeth treatment device;

FIG. 2 shows the device in FIG. 1 modified for applying a plurality of different types of treatment to teeth;

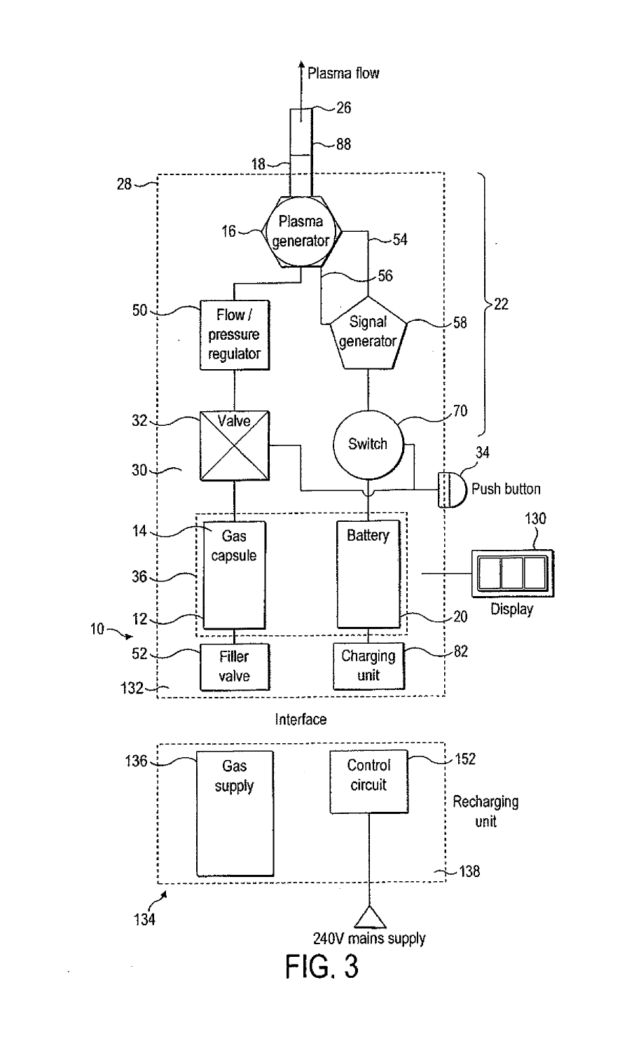

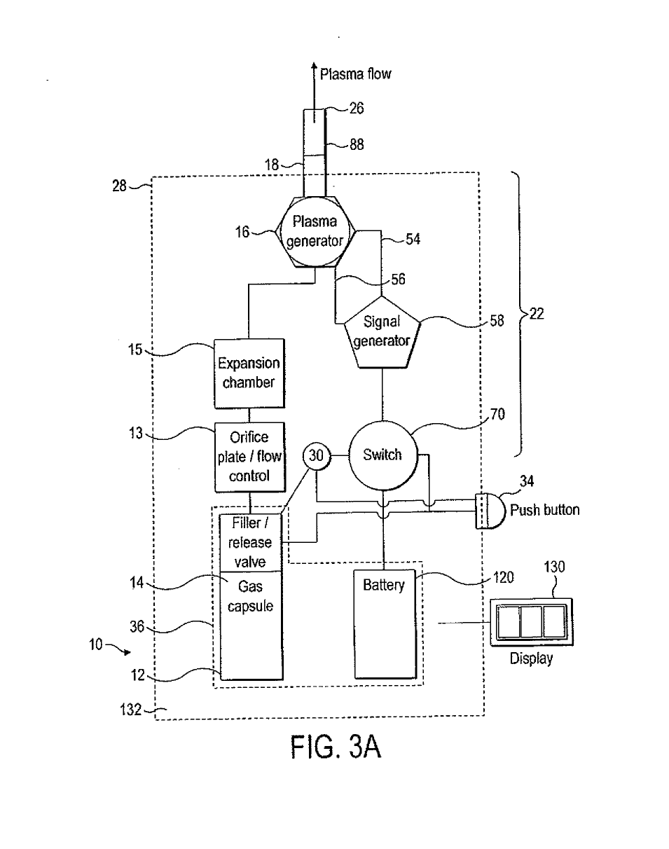

FIG. 3 shows schematically apparatus comprising a device for generating a non-thermal plasma for application to teeth and a recharging unit for recharging the device;

FIG. 3a shows a modified apparatus;

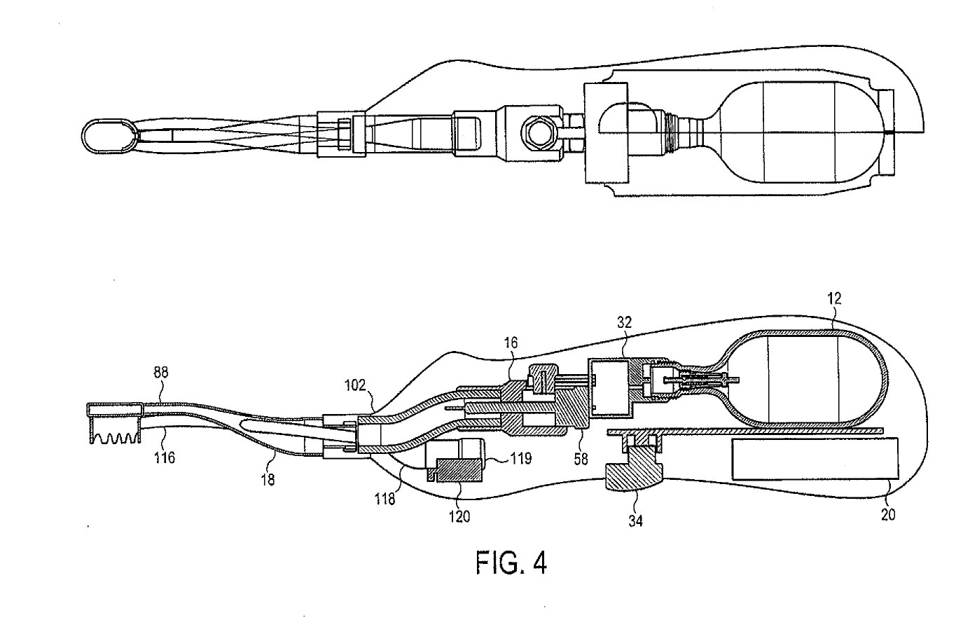

FIG. 4 show cut-away views of the device in FIG. 3;

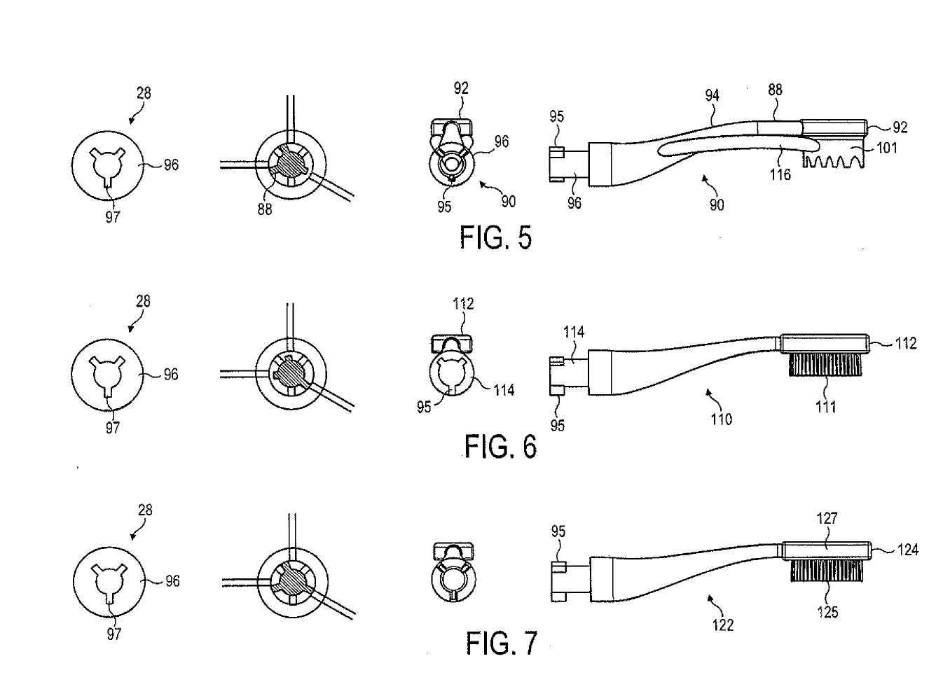

FIG. 5 shows a first applicator of the device in FIG. 3;

FIG. 6 shows a second applicator of the device in FIG. 3;

FIG. 7 shows a third applicator of the device in FIG. 3;

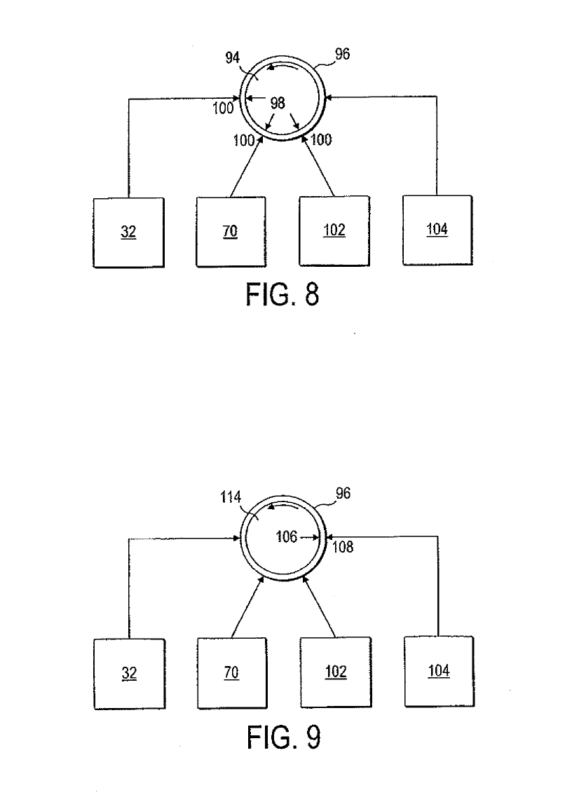

FIG. 8 shows schematically connection of the applicator shown in FIG. 5 to the housing;

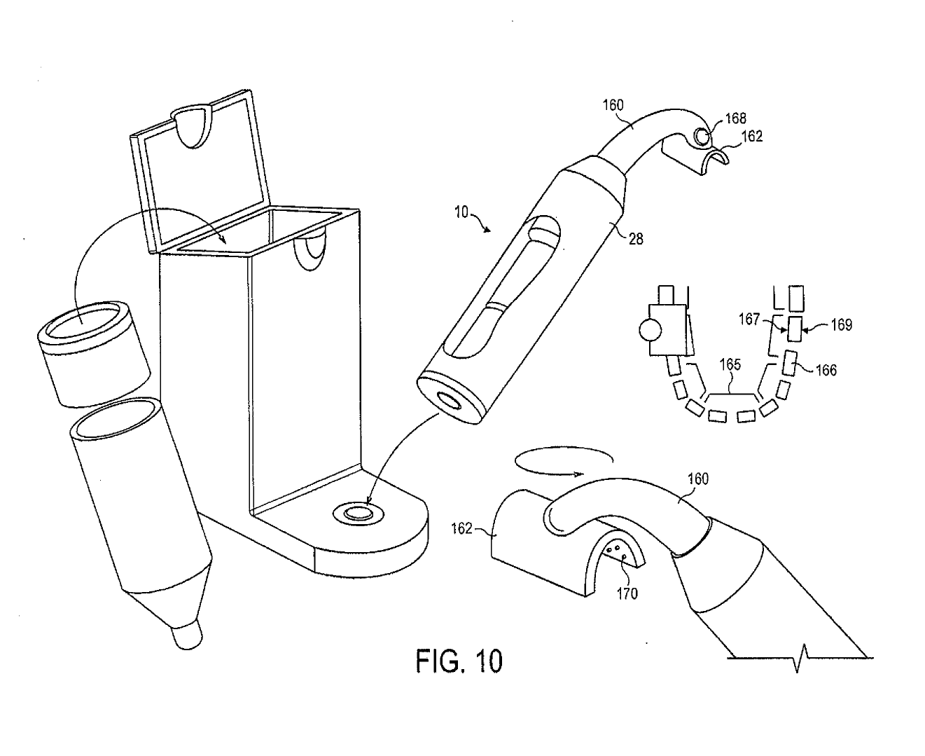

FIG. 9 shows schematically connection of the applicator shown in FIG. 6 to the housing;

FIG. 10 shows a fourth applicator of the device;

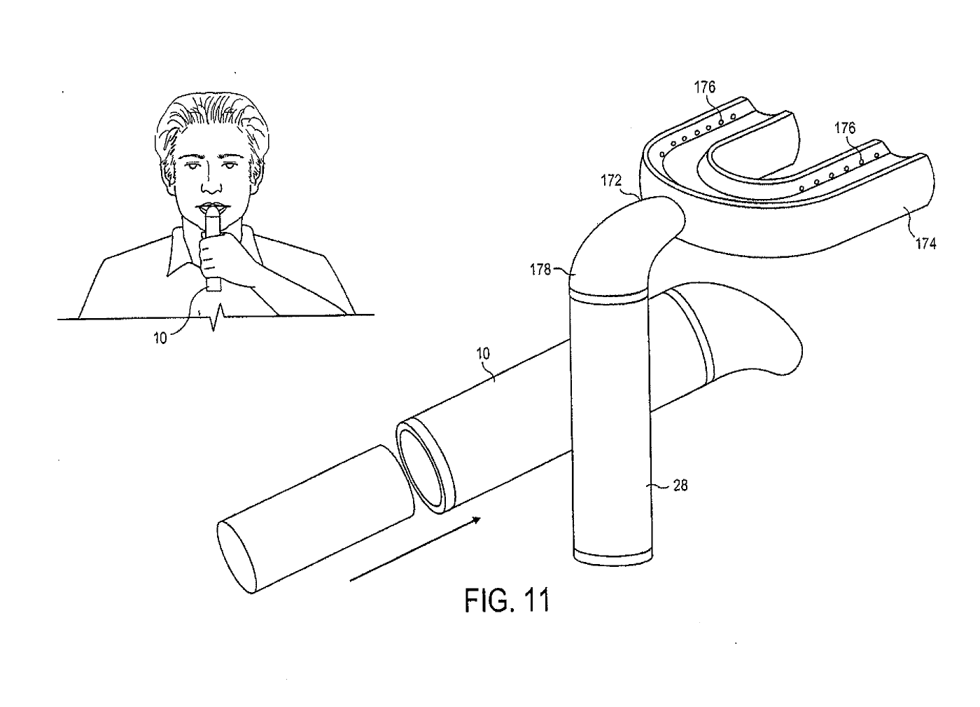

FIG. 11 shows a fifth applicator of the device;

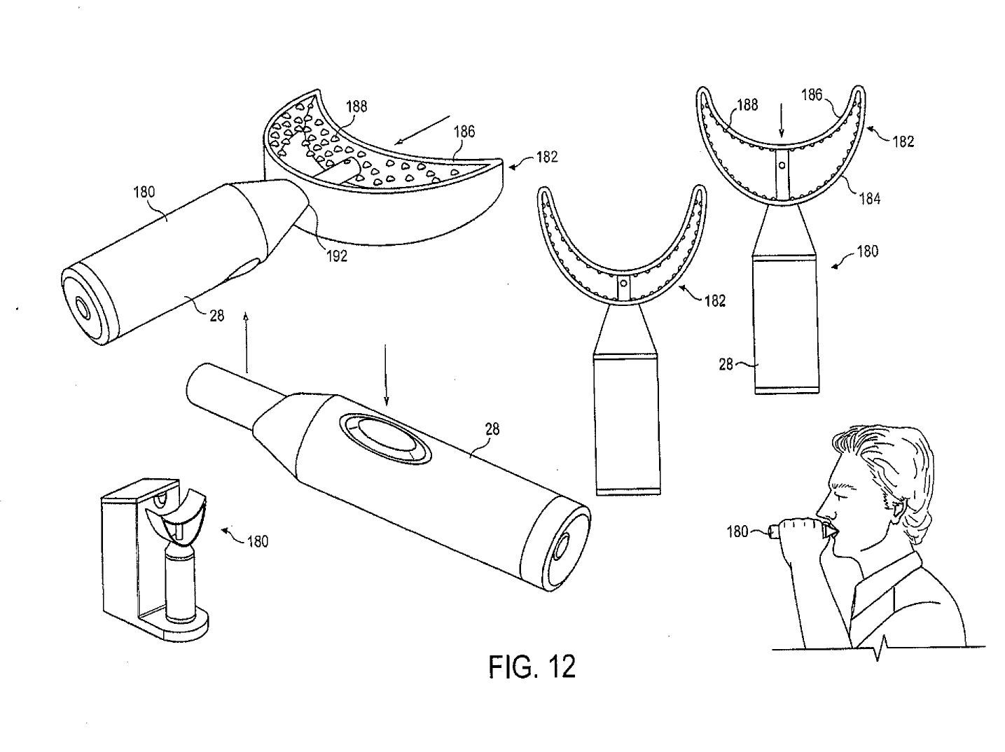

FIG. 12 shows a sixth applicator of the device;

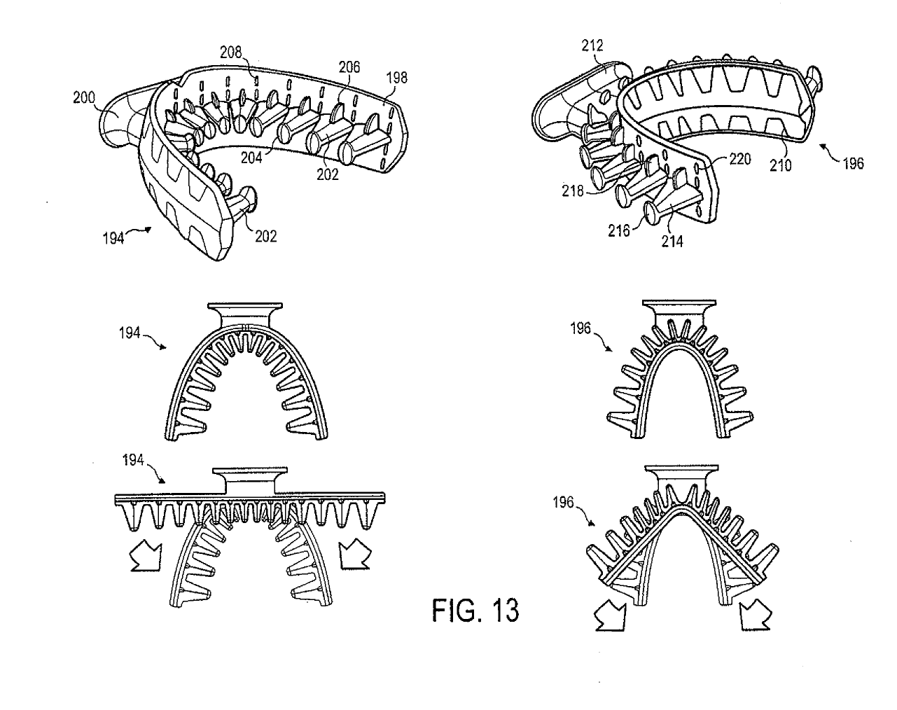

FIG. 13 shows seventh and eighth applicators of the device;

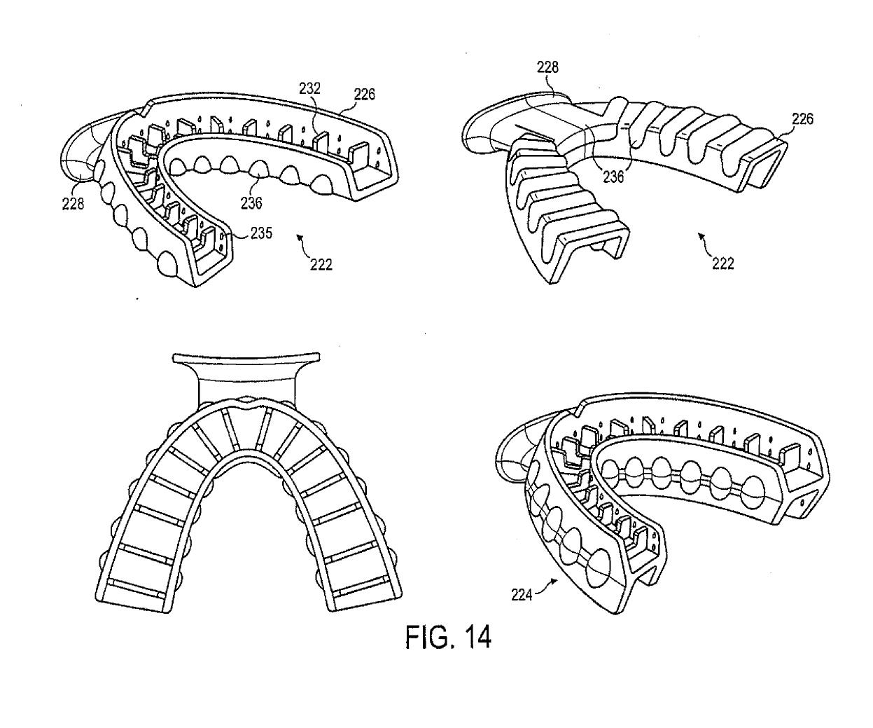

FIG. 14 shows ninth and tenth applicators of the device;

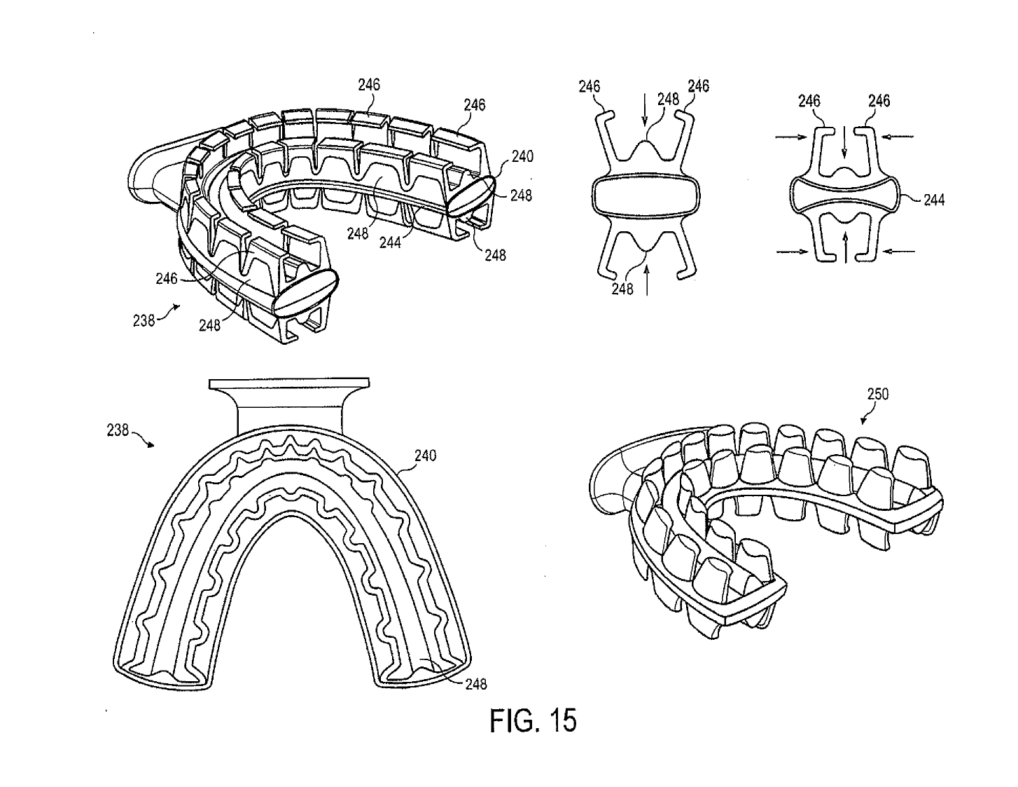

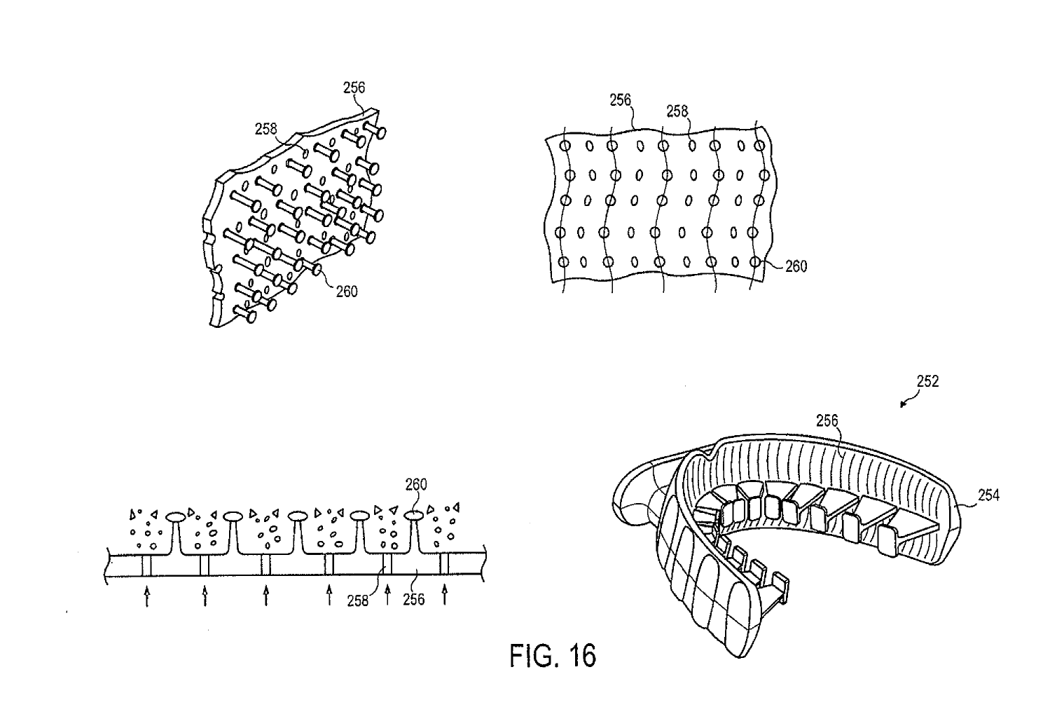

FIG. 15 shows eleventh and twelfth applicators of the device;

FIG. 16 shows a thirteenth applicator of the device; and

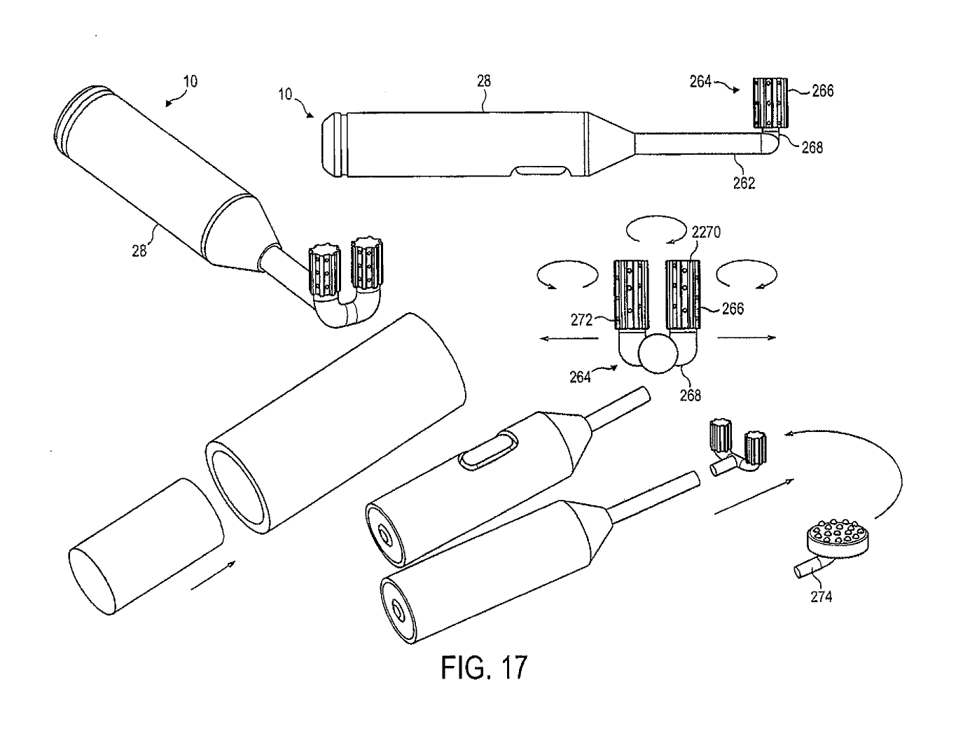

FIG. 17 shows a fourteenth applicator of the device.

Referring to FIG. 1, a hand-held teeth treatment device 1 is shown. The device 1 comprises a base, or hand, unit 2 which is configured to be hand-held and operated and an applicator 3 comprising an applicator head 4 for applying treatment to teeth. The applicator comprises a connecting portion 5 for engaging with a complementary connecting portion 6 of the base unit for connecting the applicator to the base unit. Treatment generating means 7 receives electrical energy from a source of electrical energy 8 for generating treatment for application by the applicator. Treatment activation means 5, 6 (described in more detail below with reference to FIGS. 8 and 9) allow activation of the treatment generating means only when the applicator 3 is connected to the base unit 2.

As shown in FIG. 2, the device 1 is capable of applying a plurality of different types of treatment to teeth. A plurality of applicators 3a, 3b and 3c comprise applicator heads 4a, 4b, 4c for applying different respective treatments to teeth. Each applicator has a connecting portion 5a, 5b, 5c for engaging with the complementary connecting portion 6 of the base unit for connecting the applicator to the base unit 2 such that any one of the applicators can be connected to the base unit.

The treatment activation means allows activation of the type of treatment generated according to the applicator which is connected to the base unit. For example, applicator 3a has an applicator head 4a in the form of a brush to which a reciprocating motion can be imparted by a motor for cleaning teeth. The motor may be housed in the base unit 2 but in a preferred arrangement the motor is housed in the applicator and connected to the source 8 of electrical energy via treatment activation means 5, 6. In another example, applicator 3b has an applicator head 4a in the form of a brush to which a rotating motion can be imparted by a motor for cleaning teeth. In the third example, the treatment generation means 7 is configured for generating an active gaseous species and the applicator 3c is adapted to convey species to the applicator head 4c for application to teeth. Depending on the type of species selected, the teeth may be treated for example by cleaning or whitening. The active gaseous species may be a non-thermal plasma further details of which are provided below.

Accordingly, FIG. 2 shows a teeth treatment kit comprising a device 1, there being a plurality of applicators 3a, 3b, 3c, each applicator enabling a different treatment to be performed, whereby a user can select from the plurality of applicators a particular one to perform a particular treatment. Depending on the type of applicator connected to the base unit, any one of a plurality of different treatments can be performed. For example, as shown in FIG. 2, the device can treat teeth by reciprocating or rotational motion of a brush or by application of a gaseous species to teeth. Alternatively, the device can be adapted for treatment of reciprocating and rotational motion of a brush but without the capability of application of a gaseous species. Still further and as described in more detail below, the device may be capable of applying active gaseous species, optionally with more than one applicator, but without the capability of treatment by abrasive action with a brush. An applicator may also be provided which de-activates electric action of the device so that traditional manual brushing may be performed.

Referring to FIGS. 3 and 4, a device 10 is shown for generating a non-thermal plasma 24 which may be a flow of plasma in the form of a plasma plume emitted from the device. The device is disclosed in detail in the applicant's co-pending international application entitled “Device For Generating Gaseous Species”, which was filed on the same date as the present application. The contents of the co-pending application are hereby incorporated by reference.

The treatment generating means comprises a gas capsule 12 for holding a gas 14 under pressure and forming a flow of gas through a expansion chamber 16 to an plasma generator ( ) then to an applicator 18 when released from the gas capsule and plasma generation means 22 electrically connected to a source of electrical energy for energising gas 14 in the plasma generator 16 to form a gas plasma 24.

In a modified device shown in FIG. 3a, high pressure gas may flow from the capsule through an orifice plate 13 into an expansion chamber 15 which slows flow and which can then be released in a controlled way to the reaction generator 16.

A housing 28 of the base unit houses the gas capsule 12, expansion chamber plasma chamber 16, source of electrical energy 20, and plasma energising means 22. The device is sized and of a weight such it can be held and operated by a user by hand and the gas plasma 24 readily applied by a user to treat a treatment region of an object or human or animal body. In this regard, the device is operable without the requirement for its connection by a gas line to a gas supply. The device 10 may also receive power from the source without the requirement for electrical cabling connecting the device to a mains supply. In this regard, the device is self-contained wherein during application of treatment said treatment generation means generates treatment without the device being connected to a remote source of gas and/or power. However, in other embodiments of the invention the device may be connected to receive gas or power from a supply.

The device 10 has particular utility in, for example, teeth whitening, dry cleaning of teeth, or treatment of gingivitis and periodontis. The application for teeth whitening is described in more detail in the applicant's co-pending application number GB 0823435.3 filed 23 Dec. 2008, the contents of which are hereby incorporated by reference. In this regard, the treatment region may be a single tooth, two teeth or the upper and/or lower arch of teeth. Alternatively, the treatment region may be a portion of the gingiva or a pocket. Still further, the treatment region may be the oral cavity. The flow rate of non thermal gaseous plasma may be selected according to the treatment.

The components of device 10 will now be described in more detail, giving modifications and alternatives where relevant.

A control indicated generally at 30 is provided for selectively releasing gas from the gas capsule for forming the flow of gas. As shown in this example, the control 30 comprises a valve 32 which when open allows the flow of gas through a conduit from the gas capsule optionally through an expansion chamber to the plasma generator, and when closed resists flow. The control 30 comprises a mechanical push switch 34 which can be operated by a user for controlling the valve 32.

The housing 28 comprises means 36 for locating the gas capsule 12 in the housing so that the gas capsule is operable to release gas for forming the gas flow. The housing may further comprise a gas release mechanism operable for releasing gas from the gas capsule when the locating means locates the gas capsule in the chamber.

As shown in FIG. 3 and described in more detail below, the device 10 comprises a filler valve 52 for allowing gas from a gas supply to re-fill or recharge the gas capsule 12.

The plasma energising means 22 comprises two electrodes 54, 56 for generating an electric field in the plasma chamber 16. A signal generator 58 generates an electrical signal for driving, or energising, the electrodes. At least one, and preferably both or all, of the electrodes are dielectric barrier discharge electrodes insulated from gas in the plasma generator by a dielectric to prevent heating of the plasma in response to the transfer of electrical charge between plasma in the plasma chamber and the electrodes. Suitable dielectric materials are ceramic, plastics or glass.

The plasma energising means may 22 may operate in any of one or more plasma energising modes for example alternating, DC, pulsed, and can be capacitively coupled or inductively coupled to the plasma generator In this example, the signal generator 58 is configured to generate a pulsed DC signal for driving the electrodes. The signal generator may be configured as a pulsed signal generator to generate a low duty cycle signal in which the electrical energy is provided to the electrodes for less than 10% of the duty cycle.

The control 30 is operably connected to the plasma energising means 22 for controlling energisation of, or supplying energy to, the electrodes. In this example the control 68 comprises an electrical switch 70 which when closed allows energisation of the electrodes 54, 56. The switch 70 is manually operable by a user using the previously referenced button switch 34 (which also activates valve 32). The use of the same user input device for controlling the flow of gas into the plasma chamber and the energisation of the electrodes 54, 56 is desirable because preferably gas flow and energisation of the electrodes occurs at the same time. Further, it is preferable that energisation of the electrodes does not occur unless gas flow exceeds a predetermined minimum required flow.

The source 20 of electrical energy may be one or more batteries and preferably the batteries are rechargeable. In this case, the housing 28 may comprise an electrical socket for receiving a plug connected to a mains power source and a recharging circuit 82 for recharging the batteries.

The housing 28 comprises an enclosure 84 for locating the batteries in the housing and electrical terminals (not shown) which connect to the batteries when they are located in the enclosure for supplying energy to the plasma energising means 22.

In order to permit a free range of movement of the device by a user, it is preferable that the source of electrical energy is not connected to a mains or other supply during use. It will also be appreciated that as the device may be used in a wet environment for instance a bathroom it is advantageous to avoid cabling.

Various embodiments of the applicator are shown in more detail in FIGS. 5 to 17.

Referring to FIG. 5, an applicator 90 is shown which is connectable to a housing of the device 10 for applying active gaseous species generated inside the housing 28 to an oral treatment region. The applicator 90 comprises a connecting portion 94 comprising connecting formations 95 for engaging with complementary connecting formations 96 of the housing for connecting the applicator to the housing. A duct 88 connects with the supply of active gaseous species generated in the housing when the connecting portion is connected to the housing and conveys the species from the housing to an applicator head 92. The applicator head is configured for treatment of an oral treatment region and has one aperture 99 therein in gas communication with the duct for applying species to the oral treatment region. The applicator head 92 is sized and shaped for introduction to an oral cavity for treatment of one or more teeth. In this example, the head comprises a flexible skirt 101 which can fit over two teeth so that species ejected through the aperture 99 are applied to the surfaces of the teeth. The head 92 is adapted such that when it is fitted in position substantially all of the surface area of the enamel of the teeth, and optionally a proximate portion of gingival, is exposed to plasma or other active gas species for treatment.

Two further ducts 116 are in flow communication with the applicator head for evacuating species from the treatment region to the housing after treatment. Ducts 116 form an exhaust duct in the applicator 90 extending from the treatment region and in fluid communication with pumping means 118 in the device 10. The pumping means 118 is driven by a motor 120 for pumping gas or plasma from the treatment region. It is preferable that gas or plasma is exhausted from the treatment region after treatment so that a user does not inhale significant quantities of gas or plasma.

In this example, the formations of the connecting portion are shaped protrusions 95 which are received in a respective plurality of shaped recesses 97 in the housing connecting portion 96. Once received in the recesses, the applicator and housing are relatively rotated to lock the applicator in place.

The connecting portions 94, 96 are configured to allow activation of one or more functions of the device 10 when connected and to prevent activation of functions when not connected. Similarly, as a user may choose from any one of a plurality of different applicators (described below in more detail) the connection of one applicator to the housing may allow activation of one set of functions whilst the connection of another applicator to the housing may activate another set of functions. In this regard, each applicator of a set of applicators may have a different configuration of locking recesses or locking protrusions. The connection of applicator 90 to housing 28 is configured to allow activation of the plasma energising means 22 and of gas flow to plasma chamber 16 when user input device 34 is operated. Without such connection, operation of the user input device cannot activate these functions.

As shown in FIG. 5, the connecting portions 94, 96 comprises treatment activation means which in this example comprise complementary electrical contacts which are closed to allow activation of certain, selected, functions. The arrangement is shown schematically in FIG. 8. In FIG. 8, connecting portion 94 is rotatable in connecting portion 96 to lock the applicator to the housing. When locked, electrical contacts 98 on the connecting portion 94 contact electrical contacts 100 on the connecting portion 96 thereby closing respective electronic switches allowing activation of the gas flow by valve 32, activation of the plasma energising means by switch 70, and activation of evacuation means 102.

Accordingly, if a correct applicator is not connected to the housing, gas flow and energisation is not permitted thus conserving gas and power if the push button 34 is inadvertently operated.

When a different applicator is connected to the housing different functions of the device are allowed. In this regard, FIG. 9 shows schematically an applicator 110 illustrated in more detail in FIG. 6. Applicator 110 comprises an applicator head 112 similar to a typical tooth brush comprising bristles 111 for cleaning teeth. Applicator 110 further comprises connecting portion 114 for engaging with connecting portion 96 of the housing 28. Ducting is not required in applicator 110 between the connecting portion 114 and the head 112 as the applicator 110 is designed to be used without plasma treatment. As shown in FIG. 9, when connection portion 114 is received in connecting portion 96 and rotated to lock applicator 110 to the housing 28, electrical contact 106 on connecting portion 114 contacts electrical contact 108 on the connecting portion 96 thereby closing an electronic switch allowing activation of for example a motor 104 for imparting rotating or reciprocating motion to the brush of the applicator head for aiding teeth brushing. The other functions of device 10 (32, 70, 102) are deactivated in this arrangement so that plasma is not delivered when normal teeth brushing is performed.

Although applicator 110 is shown comprising an electrical contact for activating a motor, instead connecting portion 114 may be devoid of electrical contacts and the applicator 110 is then used as a normal tooth brush with all other available treatments deactivated.

A third applicator 122 is shown in FIG. 7 which is generally similar to applicator 90 shown in FIG. 8 although with a different head and without the evacuation ducts 116. The species release portion of applicator head 124 comprises a plurality of fine hollow tubes, or fibres, 125 in the form of a brush for directing plasma or active gas species onto a treatment region such as the teeth of a user. One end of each fibre is in flow communication with the duct and the other end of each fibre forms an aperture for applying species to a tooth surface. The fine hollow tubes may be formed by any suitable technique. The tubes may be connected to a plenum chamber, or manifold cavity, 127 in the head for distributing generally equally plasma or active species to the tubes.

A fourth applicator 160 is shown in FIG. 10. Applicator 160 comprises similar features to those discussed above in relation to FIG. 3 and those similar features will not be described again in detail for brevity.

Applicator 160 is shown connected to housing 28 of device 10. An applicator head 162 is flexible curved and hollow, and sized to fit over one or more teeth 166 as shown. The head is connected to a neck portion of the applicator by a ball joint 168 to allow pivotal movement of the head relative to the rest of the device 10. A plurality of apertures 170 are formed in an inner surface of the head so that when the head is in position in an oral cavity the apertures face the teeth. The length and curvature of the head is chosen so that it can fit over each of the teeth in a typical mouth (e.g. molars and incisors) and locate the apertures 170 closely adjacent to the surface of the tooth to be treated. If the apertures are located too far from a tooth surface the species may become diluted by mixing with ambient air and therefore be less effective in treating the teeth. If the apertures are located too close to a tooth surface, the tooth surface may itself block the aperture or the species may be concentrated at only one portion of the tooth surface.

In this example, the upper and lower teeth can be treated in zones, one zone after another until the mouth is fully treated. Each zone 165 may comprise one or more teeth. The hollow interior of the head forms a plenum chamber in flow communication with both duct 88 for receiving species generated inside the housing 28 and the apertures 170 to allow a relatively equal amount of species to flow from each of the apertures. The apertures are positioned so that an inwardly facing surface 167 and an outwardly facing surface 169 of teeth in a zone are treated together.

A fifth applicator 172 is shown in FIG. 11. Applicator 172 comprises similar features to those discussed above in relation to FIG. 5 and those similar features will not be described again in detail for brevity.

Applicator 172 comprises an applicator head 174 which is generally arch shaped and sized to cover the inwardly and outwardly facing surfaces of the upper or lower teeth. A plurality of apertures 176 are formed in the inner surface of the head for applying species to the teeth. In more detail, the head 174 forms a channel for receiving a full row of either the upper or the lower teeth. The apertures are located closely adjacent to the teeth surfaces when the head is fitted so that species can flow over the exposed teeth surfaces thereby treating all the upper or lower teeth together.

The connecting portion 178 of the applicator extends through 90° for convenient holding of the housing and is swivel fitted to the head 174 so that a user can use the device 10 with the housing extending downwardly from the mouth as shown for treating both the upper and the lower teeth.

The arrangement shown in FIG. 11 is advantageous in that all of the upper or lower teeth can be treated together making efficient use of gas and reducing the time of treatment.

A sixth applicator 180 is shown in FIG. 12. Applicator 180 comprises similar features to those already discussed above and those similar features will not be described again in detail for brevity.

Applicator 180 comprises a head 182 which is configured for treating the inwardly and outwardly facing teeth surfaces of both the upper and lower teeth together. The head 182 comprises a first, front, curved piece 184 adapted to be received between the teeth and the lips and a second, rear, flexible curved piece 186 adapted to be received behind the teeth. Apertures 188 are formed in the rear surface of the front piece and in the front surface of rear piece. A connecting piece 190 extends through a hole 192 in the front piece 184 and is fixed to the rear piece 186 so that when a user fits the head 182 over their teeth, the housing 28 can be pulled to bring the front and rear pieces towards each other thereby locating the apertures 188 relatively close to the teeth. Both front and rear pieces are hollow and are in flow communication with duct 88 in the connecting piece 190 for connecting the apertures to the species generator in the housing 28.

Two further applicators 194, 196 are shown in FIG. 13. Applicator 194 is adapted for treating the outwardly facing surfaces of the upper and lower teeth and applicator 196 is adapted for treating the inwardly facing surfaces of the upper and lower teeth. Since, the outwardly and inwardly facing surfaces of the teeth may require different treatments or different exposure times, the arrangement shown in FIG. 11 may be advantageous. For example, different exposure times may be required as teeth whitening is more critical for the outwardly facing surfaces of teeth.

The applicator 194 comprises an applicator head 198 and a connecting portion 200 containing duct 88 for connecting to the supply of species. The applicator head 198 comprises locating means in the form of bite grips 202 which can be clamped between upper and lower teeth for locating the applicator head in the oral cavity. The head is flexible and biased to adopt a straight configuration. When inserted in the mouth by a user the head is curved and the user bites down on the bite grips to locate the head. The bite grips may comprise cross-extending tabs or flanges 204 to aid location. The head 198 comprises spacing means in the form of projections 206 for spacing the apertures 208 from respective teeth surfaces when the applicator head is located in the oral cavity. Spacing the apertures from the teeth in this way allows gas to spread throughout the surfaces of the teeth generally equally rather than being concentrated at one portion of a tooth surface.

The applicator 196 comprises an applicator head 210 and a connecting portion 212 containing duct 88 for connecting to the supply of species. As with applicator 194, the applicator head 210 comprises locating means in the form of bite grips 214 and flanges 216. When inserted in the mouth by a user the head is curved and the user bites down on the bite grips to locate the head. The head 210 comprises spacing means in the form of projections 218 for spacing the apertures 220 from respective teeth surfaces when the applicator head is located in the oral cavity.

The applicator heads 198, 210 are hollow and form respective plenum chambers in flow communication with duct 88 and apertures 208, 220.

Two still further applicators are shown in FIG. 14. Applicator 222 is adapted for treating the upper teeth or the lower teeth and applicator 226 is adapted for treating both upper and lower teeth together.

Applicator 222 comprises an applicator head 226 and a connecting portion 228 containing duct 88 for connecting to the supply of species. The applicator head 226 comprises locating means in the form of bite grips 230 which can be clamped between upper and lower teeth for locating the applicator head in the oral cavity. The head 226 comprises spacing means in the form of projections 232 adapted to be positioned on each side of a tooth for spacing the apertures 234 from both the front and back teeth surfaces when the applicator head is located in the oral cavity. Species entering the head through duct 88 can flow through channels 236 for ejection from apertures 235 at the front and back sections of the head for applying species to front and back surfaces of the teeth. The channels 236 are in flow communication and extend across the head from the front section to the back section.

Applicator 224 has the same construction as applicator 22 except that applicator 224 is adapted for treating both the upper and lower teeth.

Another applicator 238 is shown in FIG. 15. Applicator 238 is similar to applicator 224 and is adapted for treating both the upper and lower teeth together.

Applicator 238 comprises an applicator head 240 and a connecting portion 242 containing duct 88 for connecting to the supply of species. The head comprises a central section 244 for clamping between upper and lower teeth. Extending generally orthogonally from the central section (upwardly and downwardly as shown) are a plurality of flexible tabs 246. The tabs are disposed in pairs and each pair is adapted for enveloping a single tooth in a typical mouth. Channels 248 are formed along the central section for conveying species from the duct 88 to the apertures (not shown). Each tab 246 in a pair comprises one or more apertures for applying species to one side of a tooth. The central portion 244 is hollow and filled with a gas or gel and further comprises a ridge 248 extending along upper and lower sides of the central portion. As the head is flexible, when a user bites down on the ridge 248, the cavity is compressed and the tabs 246 bend towards the teeth as shown thus closing the distance between the apertures and the teeth. In this way, the head can easily be fitted in the mouth and located covering the teeth and when in use the central section 244 is bitten thereby closing relatively tightly around the teeth. The apertures are configured to be in a closed condition to prevent the application of species to a teeth surface when not in use and when the central section is clamped between upper and lower teeth, the apertures are opened to allow species to flow onto the teeth. Accordingly, species is not consumed until the applicator head is in place. Further, if any teeth are missing, the user cannot clamp on the ridge at the relevant point and therefore the tabs do not close on the gap in the teeth. Accordingly, the apertures do not open, thereby conserving gas usage.

A further applicator 250 is also shown in FIG. 15 which is functionally equivalent to applicator 238 but of simplified design.

Another applicator 252 is shown in FIG. 16, which is similar in construction to applicator 194 shown in FIG. 11. However, applicator 252 comprises energising means for energising gas flowing through the applicator head 254 for generating a gas plasma. The applicator head comprises an inner wall 256 in which apertures 258 are formed for applying species to the front surface of the upper and lower teeth. Extending outwardly from the wall 256 are a plurality of spacing means 260 for spacing the teeth from the wall. The wall 256 comprises an electrically conductive material which when energised causes gas flowing through the apertures to form a plasma. The spacing means 260 provide sufficient space for the energising means to act upon the gas to generate a plasma.

A further applicator 262 is shown in FIG. 17. The applicator head 264 comprises a pair of rollers 266 which are supported for rotational movement by a bracket 268. The rollers comprise a plurality of ridges 270 with apertures 272 located between the ridges. In this way, the apertures 272 are spaced from the surface of a tooth and therefore do not become blocked by the tooth surface when in use so that species can circulate without impediment. The rollers 266 are adapted to be placed either side of a row of teeth and drawn along the row applying species to the teeth as the rollers rotate. The bracket may be flexible thereby allowing the rollers to fit over the teeth and exert a small compressive force against the teeth. The applicator head 264 in this embodiment is detachable as shown and may be replaced with a different head 274.

The device 10 may comprise a single applicator for example the applicator 90 shown in FIG. 5 or alternatively the device 10 may comprise a plurality of interchangeable applicators as shown in any of FIGS. 5 to 17, each for performing a specific function. For example, it is desirable to enable a user to brush teeth in the normal way using the device 10 with applicator 110, optionally with vibration, and also to be able to treat the teeth with plasma or other active species with any one or more of the other applicators.

A recharging unit 134 is shown in FIG. 3. The recharging unit comprises a recharging pressure vessel 136 containing gas for supplying gas to the gas capsule 12 of the device 10; and electrical recharging means 138 for recharging the source of electrical energy 20 in the device. The recharging unit also comprises a control circuit 152 for receiving electrical energy from, for instance, a mains supply.

In use of the device 10 for example for whitening, cleaning, sterilising or sealing an oral region of a body, a user selects an appropriate applicator 18 for fixing to the housing 28. Depending on the applicator, selected functions of the device 10 can be activated when the user operates the user input device 34. For plasma treatment, the operation of the user input device opens valve 32, closes switch 70 and activates the evacuation means 102. Provided there is sufficient gas flow (e.g. helium) into the plasma chamber 16, the plasma energising means 22 energises gas in the plasma chamber to form a plasma. Although substantially all of the plasma chamber is exposed to an electric field, only a portion of the gas that enters the plasma chamber may be energised to form a plasma. Accordingly, a mixture of gas and plasma flows from the chamber and through the applicator 18. The user positions the applicator head so that the gas plasma mixes with atmospheric air to generate these gaseous species over the treatment region, for instance one or more teeth. During treatment, evacuation means may evacuate the mixture of gas plasma from the treatment region. When treatment is completed, the user operates the user input device 34 to deactivate gas flow, therefore the plasma energising means 22 and the evacuation means 102.

Inevitably, some plasma interacts with ambient air (e.g. oxygen, nitrogen and argon) causing some chemical break-down forming other active gaseous species. For example, the interaction of the plasma with oxygen may form ozone. Ozone is a strong oxidant and can contribute to the beneficial, or therapeutic, effect on the treatment region as is the case with other active gaseous species.

In another embodiment, a device is configured to generate ozone or other active gaseous species without the generation of a non-thermal plasma or by using other energising techniques.

Such a device generates a flow of a non-thermal gaseous species and has equivalent features to device 10 except where otherwise stated. The device comprises a gas capsule for holding a pressurised gas and forming a flow of gas through to a reaction chamber to an applicator when released from the gas capsule. Gas released from the gas capsule is energised in the reaction chamber, or plasma generator, to form an active gaseous species.

The device further comprises a source of electrical energy and energising means electrically connected to the source of electrical energy for energising gas in the reaction chamber to form the gaseous species.

An applicator directs the flow of gaseous species from the reaction chamber for generating a flow of gaseous species from the device. A housing houses the gas capsule, reaction chamber, source of electrical energy, and energising means. The housing is sized and of a weight such that the device can be held and operated by a user by hand and the flow of gaseous species directed to treat the user's teeth. The pressure vessel may contain oxygen and in this case the gaseous species formed is ozone.

1. A hand-held teeth treatment device for applying a plurality of different types of treatment to teeth, comprising:
a hand unit which is configured to be hand-held and -operated, and comprises a source of electrical energy;
a plurality of interchangeable applicators comprising applicator heads for applying different respective treatments to teeth, each of said applicators having a connecting portion for engaging with a complementary connecting portion of the base unit for connecting the applicator to the base unit such that any one of said applicators can be connected to said base unit;
treatment generating means for receiving electrical energy from said source, the treatment generating means being configured for generating an active gaseous species for application by at least a chosen one of the applicators when the chosen applicator is connected to said base unit; and
treatment activation means for allowing generation of a type of treatment according to the respective applicator connected to the base unit, wherein the connecting portion of each of said applicators comprises means co-operable with the connecting portion of the base unit for selecting the type of treatment which can be generated by the device when the applicator is connected to the base unit.

2. A device as claimed in claim 1, wherein said treatment generating means is capable of generating any one of a plurality of different types of treatment and said treatment activation means allows generation of any one type of treatment only when a selected said applicator associated with said one type of treatment is connected to the base unit.

3. A device as claimed in claim 1, wherein one of each applicator and the base unit comprises locking protrusions and the other of each applicator and the base unit comprises locking recesses for receiving the locking protrusions for locking the applicator to the base unit.

4. A device as claimed in claim 3, wherein each applicator has a different configuration of locking receivers or lock protrusions.

5. A device as claimed in claim 1, wherein said active gaseous species is a non-thermal plasma.

6. A device or kit as claimed in claim 1, said base unit being self-contained, wherein during application of treatment, the treatment generating means operates without the base unit being connected to a remote source of gas and power.

7. (canceled)

8. A device as claimed in claim 1, wherein each said applicator head is configured for applying one type of treatment to teeth and the connecting portion of each said applicator is co-operable with said treatment activation means when the applicator is connected to the base unit for allowing generation of only said one type of treatment by said treatment generating means.

9. A device as claimed in claim 8, comprising a duct for connecting with a supply of active gaseous species generated in the base unit when the applicator is connected to the base unit for conveying species from the base unit to the applicator head; wherein the applicator head comprises at least one aperture therein in gas communication with the duct for applying species to an oral treatment region.

10. A device as claimed in claim 9, wherein the applicator head comprises an envelope which is sized and shaped to cover an inwardly and/or outwardly facing surface of one or more teeth and said at least one aperture is formed in the envelope for applying species to said teeth surface.

11. A device as claimed in claim 10, wherein the envelope is shaped in the form of an arch and sized to cover the inwardly and/or outwardly facing surfaces of the upper and/or lower teeth and a respective plurality of said apertures are formed in said envelope for applying species to said inwardly and/or said outwardly facing teeth surfaces.

12. A device as claimed in claim 11, wherein each of the apertures are configured to be in a closed condition to prevent the application of species to teeth and when clamped between upper and lower teeth, the apertures are opened to allow said application.

13. A device as claimed in claim 8, comprising a motor for receiving electrical energy from said source when the applicator is connected to the base unit, said motor when activated causing movement of said applicator head.

14. A device as claimed in claim 13, wherein said applicator head comprising a brush and said motor is adapted for causing one of reciprocating, rotational or vibrational movement of said brush.
